(19) United States
(12) Patent Application Publication
(10) Pub. No.: US 2023/0376735 A1
(43) Pub. Date: Nov. 23, 2023

(54) NEURAL TOPOLOGICAL ORDERING

(71) Applicant: QUALCOMM Incorporated, San Diego, CA (US)

(72) Inventors: Corrado RAINONE, Haarlem (NL); Mukul GAGRANI, San Diego, CA (US); Yang YANG, San Diego, CA (US); Roberto BONDESAN, London (GB); Edward TEAGUE, San Diego, CA (US); Christopher LOTT, San Diego, CA (US); Wonseok JEON, San Diego, CA (US); Weiliang ZENG, San Diego, CA (US); Piero ZAPPI, La Jolla, CA (US); Herke VAN HOOF, Diemen (NL)

(21) Appl. No.: 18/103,757

(22) Filed: Jan. 31, 2023

Related U.S. Application Data
(60) Provisional application No. 63/343,961, filed on May 19, 2022.

(51) Int. Cl. G06N 3/047; G06N 3/10

(52) U.S. Cl. CPC G06N 3/047; G06N 3/10

(57) ABSTRACT

A processor-implemented method for generating a topological order using an artificial neural network (ANN) includes receiving a set of tasks to be performed. The tasks are represented in a graph including multiple nodes connected by edges. Each node corresponds to a task in the set of tasks. A scheduling priority is assigned to each node in the graph. A next node of potential next nodes is selected according to a probability of each of the potential next nodes based on the assigned scheduling priorities and a topology of the graph. A topological order of the tasks is generated by repeating the selection of the next node.

### CROSS-REFERENCE TO RELATED APPLICATION

The present application claims the benefit of U.S. Provisional Patent Application No. 63/343,961, filed on May 19, 2022, and titled “NEURAL TOPOLOGICAL ORDERING,” the disclosure of which is expressly incorporated by reference in its entirety.

### FIELD OF THE DISCLOSURE

Aspects of the present disclosure generally relate to neural topological ordering.

### BACKGROUND

Artificial neural networks may comprise interconnected groups of artificial neurons (e.g., neuron models). The artificial neural network may be a computational device or be represented as a method to be performed by a computational device. Convolutional neural networks (CNNs) are a type of feed-forward artificial neural network. Convolutional neural networks may include collections of neurons that each have a receptive field and that collectively tile an input space. Convolutional neural networks, such as deep convolutional neural networks (DCNs), have numerous applications. In particular, these neural network architectures are used in various technologies, such as image recognition, speech recognition, acoustic scene classification, keyword spotting, autonomous driving, and other classification tasks.

Many problems in operations research involve performing a sequence of tasks, while both obeying a set of precedence constraints between them and optimizing a cost metric of interest. Conventional approaches treat such problems via heuristic strategies, designed for general input distribution that are not tailored for problem-specific input distributions. Some heuristic strategies are handcrafted for each instance, which is time consuming and requires domain knowledge.

### SUMMARY

The present disclosure is set forth in the independent claims, respectively. Some aspects of the disclosure are described in the dependent claims.

In one aspect of the present disclosure, a processor-implemented method includes receiving a set of tasks to be performed. The processor-implemented method further includes representing the set of tasks in a graph including multiple nodes connected by edges. Each node corresponds to a task in the set of tasks. The processor-implemented method still further includes assigning a scheduling priority to each node in the graph. The processor-implemented method also includes selecting a next node of potential next nodes according to a probability of each of the potential next nodes based at least in part on the assigned scheduling priorities and a topology of the graph. The processor-implemented method further includes generating a topological order of the tasks by repeating the selecting of the next node.

Another aspect of the present disclosure is directed to an apparatus including means for receiving a set of tasks to be performed. The apparatus further includes means for representing the set of tasks in a graph including multiple nodes connected by edges. Each node corresponds to a task in the set of tasks. The apparatus still further includes means for assigning a scheduling priority to each node in the graph. The apparatus also includes means for selecting a next node of potential next nodes according to a probability of each of the potential next nodes based at least in part on the assigned scheduling priorities and a topology of the graph. The apparatus further includes means for generating a topological order of the tasks by repeating the selecting of the next node.

In another aspect of the present disclosure, a non-transitory computer-readable medium with non-transitory program code recorded thereon is disclosed. The program code is executed by a processor and includes program code to receive a set of tasks to be performed. The program code further includes program code to represent the set of tasks in a graph including multiple nodes connected by edges. Each node corresponds to a task in the set of tasks. The program code still further includes program code to assign a scheduling priority to each node in the graph. The program code also includes program code to select a next node of potential next nodes according to a probability of each of the potential next nodes based at least in part on the assigned scheduling priorities and a topology of the graph. The program code further includes program code to generate a topological order of the tasks by repeating the selecting of the next node.

Another aspect of the present disclosure is directed to an apparatus having a memory and one or more processors coupled to the memory. The processor(s) is configured to receive a set of tasks to be performed. The processor(s) is further configured to represent the set of tasks in a graph including multiple nodes connected by edges. Each node corresponds to a task in the set of tasks. The processor(s) is still further configured to assign a scheduling priority to each node in the graph. The processor(s) is also configured to select a next node of potential next nodes according to a probability of each of the potential next nodes based at least in part on the assigned scheduling priorities and a topology of the graph. The processor(s) is further configured to generate a topological order of the tasks by repeating the selecting of the next node.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with aspects of the present disclosure.

FIG. 2D is a diagram illustrating an exemplary deep convolutional network (DCN) in accordance with aspects of the present disclosure.

FIG. 3 is a block diagram illustrating an exemplary deep convolutional network (DCN) in accordance with aspects of the present disclosure.

FIG. 4 is a block diagram illustrating an exemplary software architecture that may modularize artificial intelligence (AI) functions, in accordance with aspects of the present disclosure.

FIG. 5 is a block diagram illustrating an example architecture for determining a topological order, in accordance with aspects of the present disclosure.

FIG. 6 is a diagram illustrating example graph topological transforms in accordance with aspects of the present disclosure.

FIG. 7 is a flow diagram illustrating a processor-implemented method for generating a topological order using an artificial neural network, in accordance with aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Many problems in computer science may involve finding the best sequence of objects consistent with some precedence constraints. An intuitive example may be found in routing problems, where one objective is to find the shortest route between cities. Additionally, there may be caveats (e.g., regarding a pickup and subsequent delivery of a package) on the order in which the cities should be visited. Another example may be found in compiler pipelines, which involve finding a shortest duration for executing a set of operations. Operations to be executed, like cities in the previous example, may be subject to certain constraints. The constraints may come from the data dependencies between the operations, such as when the result of an operation is an operand in a subsequent operation, for instance. As such, the prior operations may serve as precedence constraints for the dependent operation. In this example, the metric to be optimized may, for instance, be the run time of the compiled program, the memory specified to execute the program or other performance metrics. One approach for addressing such problems involves formulating the problems in term of finding an optimal topological order of a directed acyclic graph (DAG) that encodes a precedence constraint (e.g., order of execution). However, doing so induces a combinatorial optimization (CO) problem that is generally computationally complex (e.g., np-hard).

Conventional approaches applied to CO problems may encapsulate heuristic methods with designs that involve extensive use of domain-specific and problem-specific knowledge, across decades of development. Furthermore, treating such problems via heuristic strategies, which are handcrafted or custom for each instance, is time consuming.

To address these and other challenges, aspects of the present disclosure are directed to topological ordering using an artificial neural network. In accordance with aspects of the present disclosure, an end-to-end machine learning-based approach for topological ordering uses an encoder-decoder framework. The encoder may be configured as an attention-based graph neural network architecture that utilizes different topological transforms of a directed acyclic graph (DAG) for message passing. A DAG is a finite directed graph with no direct cycles. The graph may include a set of nodes connected by edges. Each of the nodes may represent a task to be performed and the edges may indicate an order for performing the represented tasks.

Node embeddings produced by the encoder of the attention-based graph neural network architecture may be converted into node priorities, which may be used by a decoder to generate a probability distribution over topological orders. In some aspects, the attention-based graph neural network architecture may, for example, be trained on a dataset of synthetically generated graphs called layered graphs.

Accordingly, the attention-based graph neural network may determine a topological order, and in some aspects, an optimal topological order. As such, aspects of the present disclosure may beneficially reduce memory and energy consumption. Moreover, aspects of the present disclosure employ a non-auto-regressive technique for parametrizing the probability distribution of topological orders. That is, rather than using an auto-regressive approach in which a topological order is determined one node at a time with each forward pass of the neural network, aspects of the present disclosure may provide the topological order with a single forward pass of the neural network. As a result, aspects of the present disclosure may improve performance (e.g., reduced memory consumption) with significantly lower run time than auto-regressive approaches.

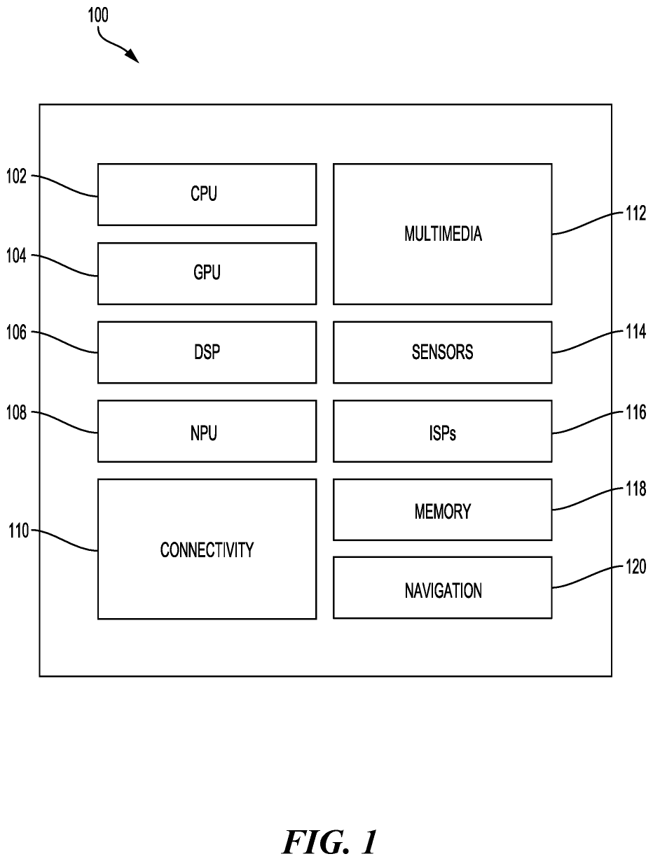

FIG. 1 illustrates an example implementation of a system-on-a-chip (SOC) 100, which may include a central processing unit (CPU) 102 or a multi-core CPU configured for generating a topological order using an artificial neural network. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In aspects of the present disclosure, the instructions loaded into the general-purpose processor 102 may include code to receive a set of tasks to be performed. The general-purpose processor 102 may also include code to represent the tasks in a graph including multiple nodes connected by edges. Each node corresponds to a task in the set of tasks. The general-purpose processor 102 may also include code to assign a scheduling priority to each node in the graph. The general-purpose processor 102 may also include code to select a next node of potential next nodes according to a probability of each of the potential next nodes based on the assigned scheduling priorities and a topology of the graph. The general-purpose processor 102 may also include code to generate a topological order of the tasks by repeating the selection of the next node.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

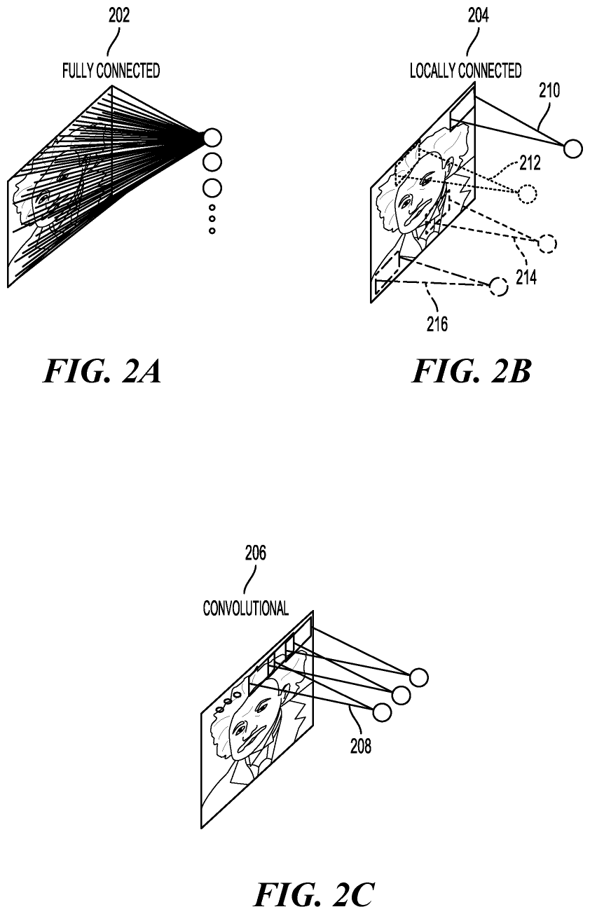

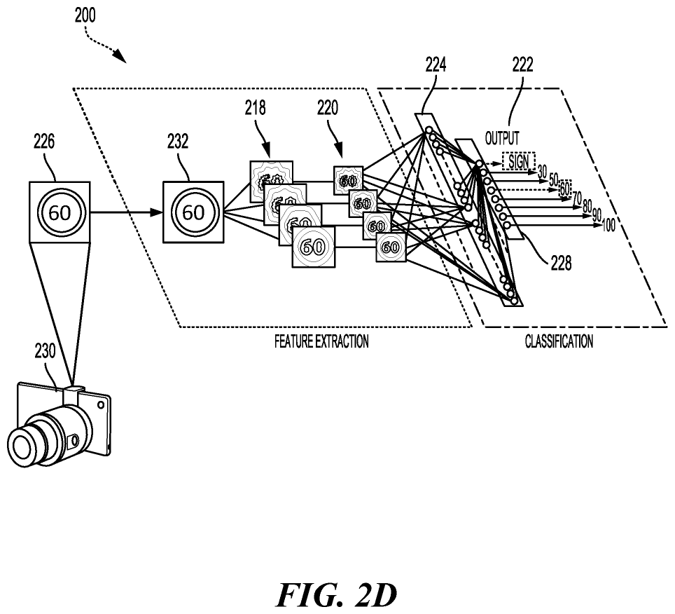

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

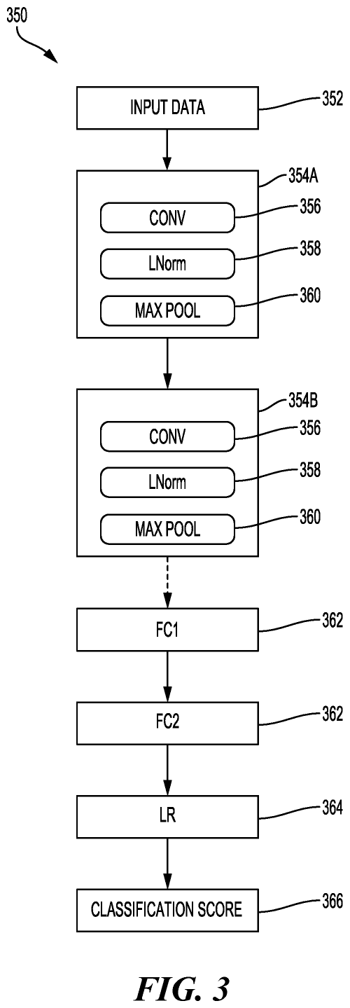

FIG. 3 is a block diagram illustrating a DCN 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360. Although only two of the convolution blocks 354A, 354B are shown, the present disclosure is not so limiting, and instead, any number of the convolution blocks 354A, 354B may be included in the deep convolutional network 350 according to design preference.

The convolution layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layers 360 may provide down sampling aggregation over space for local invariance and dimensionality reduction.

The parallel filter banks, for example, of a deep convolutional network may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the deep convolutional network 350 may access other processing blocks that may be present on the SOC 100, such as sensor processor 114 and navigation module 120, dedicated, respectively, to sensors and navigation.

The deep convolutional network 350 may also include one or more fully connected layers 362 (FC1 and FC2). The deep convolutional network 350 may further include a logistic regression (LR) layer 364. Between each layer 356, 358, 360, 362, 364 of the deep convolutional network 350 are weights (not shown) that are to be updated. The output of each of the layers (e.g., 356, 358, 360, 362, 364) may serve as an input of a succeeding one of the layers (e.g., 356, 358, 360, 362, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

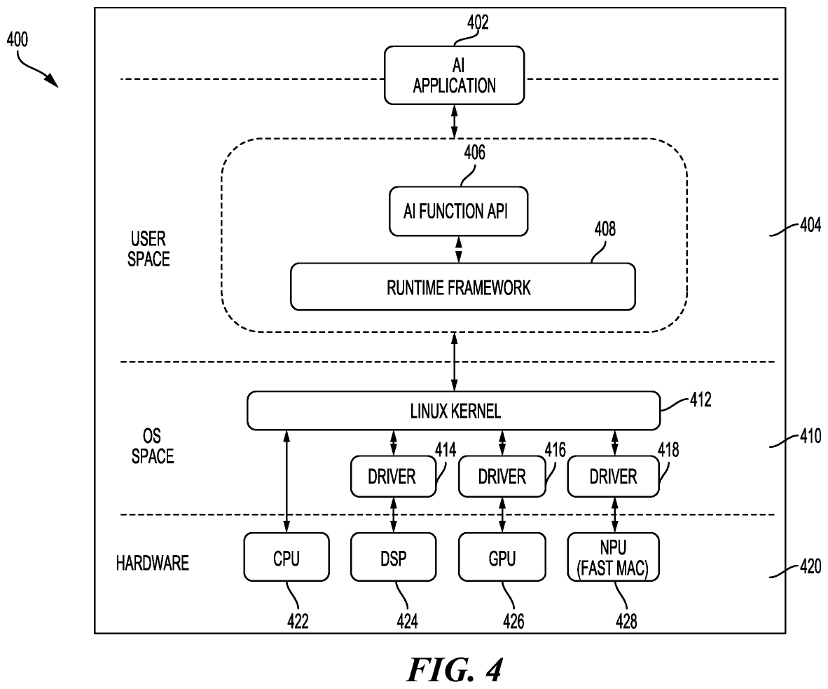

FIG. 4 is a block diagram illustrating an exemplary software architecture 400 that may modularize artificial intelligence (AI) functions. Using the architecture 400, applications may be designed that may cause various processing blocks of an SOC 420 (for example a CPU 422, a DSP 424, a GPU 426 and/or an NPU 428) (which may be similar to SoC 100 of FIG. 1) to support neural topological ordering for an AI application 402, according to aspects of the present disclosure. The architecture 400 may, for example, be included in a computational device, such as a smartphone.

The AI application 402 may be configured to call functions defined in a user space 404 that may, for example, provide for the detection and recognition of a scene indicative of the location at which the computational device including the architecture 400 currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

A run-time engine 408, which may be compiled code of a runtime framework, may be further accessible to the AI application 402. The AI application 402 may cause the run-time engine 408, for example, to request an inference at a particular time interval or triggered by an event detected by the user interface of the AI application 402. When caused to provide an inference response, the run-time engine 408 may in turn send a signal to an operating system in an operating system (OS) space 410, such as a Kernel 412, running on the SOC 420. In some examples, the Kernel 412 may be a LINUX Kernel. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

The application 402 (e.g., an AI application) may be configured to call functions defined in the user space 404 that may, for example, provide for the detection and recognition of a scene indicative of the location in which the device currently operates. The application 402 may, for example, configure a microphone and a camera differently depending on whether the recognized scene is an office, a lecture hall, a restaurant, or an outdoor setting such as a lake. The application 402 may make a request to compiled program code associated with a library defined in a SceneDetect application programming interface (API) 406 to provide an estimate of the current scene. This request may ultimately rely on the output of a differential neural network configured to provide scene estimates based on video and positioning data, for example.

A run-time engine 408, which may be compiled code of a Runtime Framework, may be further accessible to the application 402. The application 402 may cause the run-time engine, for example, to request a scene estimate at a particular time interval or triggered by an event detected by the user interface of the application. When caused to estimate the scene, the run-time engine may in turn send a signal to an operating system 410, such as a Linux Kernel 412, running on the SOC 420. The operating system 410, in turn, may cause a computation to be performed on the CPU 422, the DSP 424, the GPU 426, the NPU 428, or some combination thereof. The CPU 422 may be accessed directly by the operating system, and other processing blocks may be accessed through a driver, such as a driver 414-418 for a DSP 424, for a GPU 426, or for an NPU 428. In the exemplary example, the differential neural network may be configured to run on a combination of processing blocks, such as a CPU 422 and a GPU 426, or may be run on an NPU 428.

As described, aspects of the present disclosure are directed to topological ordering using an artificial neural network. In accordance with aspects of the present disclosure, precedence constraints for a sequence of tasks may be represented via a graph, such as a directed acyclic graph, for example. A directed graph is a tuple G=(V, E), where Vis the set of vertices and E⊆V×V is the set of edges between the vertices. A tuple is a finite ordered list or sequence of elements. A cycle is a sequence of edges i→ . . . →i with at least one directed edge. Thus, a directed acyclic graph (DAG) is a finite directed graph with no direct cycles. The graph may include a set of nodes connected by edges. Each of the nodes may represent a task to be performed and the edges may indicate an order for performing the represented tasks.

A partial order is an irreflexive transitive relation < between certain pairs of the set V. A pair (x, y)∈V×V that is related by < is referred to as comparable, and incomparable otherwise. A DAG G=(V, E) may be mapped to a partially ordered set (V, <) where x<y if there is a directed path from node x to node y. Multiple DAGs may map to the same partial order. For example, DAGs with vertex set {x, y, z} and edge sets E={x→y, y→z} and E′={x→y, y→z, x→z}, where s→t denotes a directed edge from s to t, correspond to the same partial order x<y<z. A transitive closure (TC) of a DAG may be defined as the graph with the most edges having the same underlying partial order, so that there exists a directed edge (x, y) whenever x<y. Conversely, the transitive reduction (TR) may be defined as the graph with least edges that results in the same partial order. The order induced by a DAG is denoted by <_{G}.

A topological order or sorting of a DAG G may be considered a bijection σ: V→{1, . . . , |V|} such that σ(x)<σ(y) whenever x<_{G} y. The set [symbol] of topological orders of G is a subset of the permutation group of the vertices and coincides with total orders on V that respect <_{G}, called linear extensions of the partial order.

Deciding the schedule of operations in a computational graph representing a neural network is a central problem in compilers. A DAG may be associated with a computational graph in such a way that nodes represent operations (“ops”), and incoming/outgoing edges represent operands/results of these operations. Every time an operation executes, the inputs to that operation are stored in memory, and memory for the outputs has to be allocated. Thus, each node of the DAG carries a label in: V→ [symbol] specifying the memory to store the output of that operation. A first step in scheduling a DAG is to identify topological orders to execute operations. Compilers for edge devices, which have limited memory, may aim at choosing a topological order that minimizes the peak memory footprint. In some aspects, a topological order may be determined to reduce the peak local memory usage. For instance, this task may be formulated as the following combinatorial optimization problem on a labeled DAG G=(V, E, m):

$${min}_{σ ∈ {G}_{}} ( σ ) , ( σ ) = max ( {1}_{} ( σ ) , … , {V \vert}_{} ( σ ) ) , \qquad ( 1 )$$

with the definitions

[symbol]

=Iₜ₋₁+ [symbol] (σₜ), (2)

Iₜ= [symbol] −Σ_{i∈S}_{ₜ} [symbol] ,Sₜ={i:i∉Uᵢ₌₀^{t-1}Sₗ and ∀(i,j)∈E,j∈σ_{1:t}}, (3)

where the memory usage at time t is given by the memory usage Iₜ₋₁ of the outputs that have not yet been consumed, at time t−1, by downstream operations, plus the memory utilization of the output of operation σ(t). The value Iₜ is, in turn, obtained by subtracting from [symbol] the memory costs of nodes whose outgoing edges only connect to already scheduled nodes (e.g., nodes whose output is only used by already scheduled operations). Naturally, I₀=0, S₀=Ø.

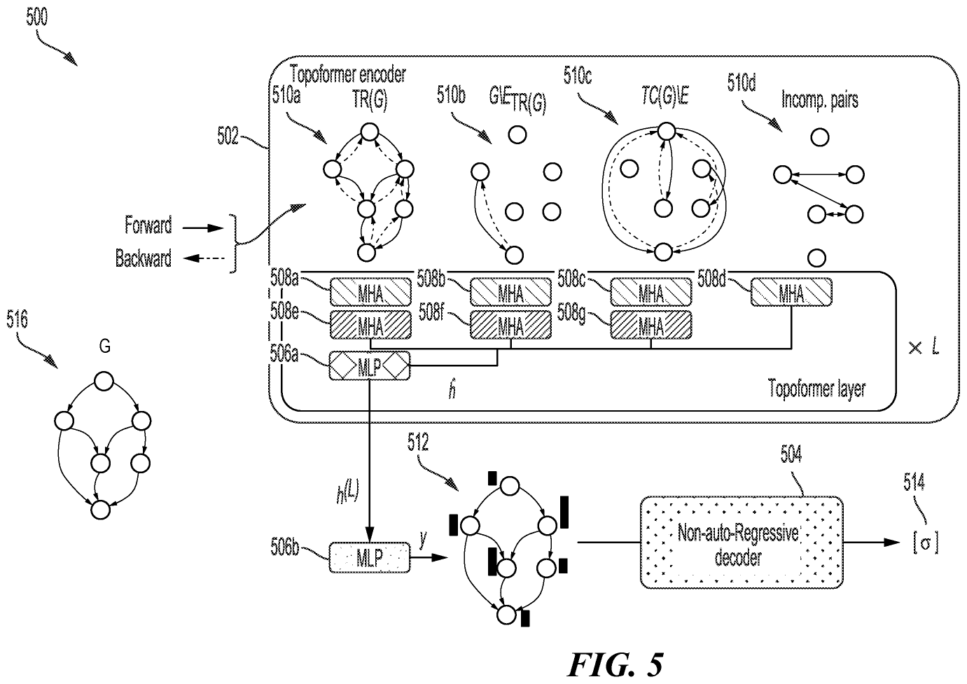

FIG. 5 is a block diagram illustrating an example architecture 500 for determining a topological order, in accordance with aspects of the present disclosure. The architecture 500 includes an encoder 502 and a decoder 504. The encoder 502 may be configured as an attention-based graph neural network. The encoder 502 may include a set of multi-head attention layers, which may be used to derive an embedding for each node of the graph G 516. The graph G 516 may comprise a DAG, for instance. The node embeddings may be supplied to the decoder 504 and may be used to generate a distribution in the sequence space. The distribution may be converted to a sequence using an inference method such as sampling inference, greedy inference, or beam search, for example.

A graph neural network (GNN) may encode a scheduling problem via the embedding of the graph G nodes. GNN architectures may operate by updating these embeddings via the aggregation of “messages” sent from the other nodes, usually in the form of some function of their own embedding.

In accordance with aspects of the present disclosure, the encoder 502 takes a vector xᵢ of input features and generates an initial node embedding h(0) via a node-wise linear transformation, hᵢ⁽⁰⁾=Wxᵢ+b. Subsequently, a succession of L attention layers, each of them comprising a multi-head attention (MHA) sub-layer followed by a node-wise multilayer perceptron (MLP) 506, which updates these embeddings. A topological inductive bias may be applied to the embedding updates by having a separate group of one or more attention heads (e.g., 508 a-g) masked by each of the following graphs induced by the original graph G (516). For instance, as shown in the example of FIG. 5, MHAs 508a-d are shaded to indicate how the MHAs may operate separately on forward versions of topological transforms 510a-d of graph G, respectively. On the other hand, MHAs 508e-g are unshaded to indicate how the MHAs may operate separately on backward versions of topological transforms of the graph G 510a-c, respectively.

In doing so, the encoder 502 may generate node embeddings to pass messages on different topological transforms of the graph G (e.g., 516). The topological transforms may include an initial graph G (e.g., 516), a transitive reduction (e.g., 510a), a transitive closure (e.g., 510c), and incomparable node pairs (e.g., 510d). The transitive reduction (TR) may be performed to yield a directed graph obtained by removing TR edges (e.g., 510c). The resulting directed graph (e.g., 510c) may be generated by removing as many edges as possible without affecting the reachability relation (e.g., partial order) between nodes from the graph G: G\E_{TR(G)}. The transitive closure transform aims to add as many edges as possible without affecting the reachability relation (e.g., partial order) between nodes. Applying the transitive closure (TC) transform may yield a directed graph obtained by removing the edges of the graph G from its TC: TC(G)\E. The incomparable node pairs transform preserves all nodes that do not have a precedence relationship. Applying the incomparable node pairs transform, an undirected graph may be obtained by joining all incomparable node pairs.

Additionally, the topological transforms may include the inverse of each of the graphs resulting from the TR transform and the TC transform. The inverse or backwards versions of the graphs (510a-c) may be obtained by flipping the edges (e.g., direction of the arrows connecting the nodes) of each graph 510a-c.

By adding these topologically transformed graphs (e.g., 510a-d) and the inverse of topologically transformed graphs 520a-c, a fully connected graph relative to the node set V may be obtained, where all nodes attend to all nodes. Then effectively, the propagation rules of the encoder 502 may be such that

ĥᵢ^{(l)}=hᵢ^{(l-1)}+concatⱼ[MHAᵢ^{l,j}(hᵢ^{(l-1)}, . . . ,h_{|V|}⁽ⁱ⁻¹⁾;Mⱼ)], (4)

hᵢ^{(l)}=ĥᵢ^{(l)}+MLP^{(l)}(ĥᵢ^{(l)}), (5)

where M^{j} is a mask that ensures that head j (e.g., MHA 508a-g) only attends to its assigned graph (e.g., topologically transformed graph 510a-d). A layer normalization may be applied to the MHA (e.g., 508a-g) and MLP (e.g., 506a-b) inputs. The number of attention heads (e.g., MHA 508a-g) assigned to each topologically transformed graph 510a-d may be chosen independently (e.g., setting it to zero means to not message-pass along the edges of the respective graph), or parameters may be tied or shared among different MHAs (e.g., 508a-g). Each of the nodes may influence each other's representation, while also injecting a strong inductive bias based on the graph G (e.g., 516) structure.

The decoder 504 may derive a stochastic policy p(σ|G) over valid topological orders of the graph G. For instance, the stochastic policy p(σ|G) may be given by:

p(σ|G)=Πₜ₌₂^{|V|}p_{θ}(σₜ|σ_{1:t-1},h,G)×p_{θ}(σ₁|h,G), (6)

A complete sequence could be sampled by autoregressively choosing a new node at each step. However, doing so is very time consuming because when a neural network (NN) is used as a function approximator for p_{θ}, it also requires that |V| calls to this NN be performed, which limits its feasibility to relatively small graphs due to the amount of computation employed.

Accordingly, in order to scale to large graphs, a non-auto-regressive (NAR) approach that decouples the number of NN calls from the graph size may be employed. Scheduling priorities [symbol] ᵢ∈ [symbol] may be assigned to the nodes, rather than scheduling probabilities. The priority for node i may be derived by passing its final embedding through an MLP 506:

[symbol]

ᵢ=MLP(hᵢ^{(L)}). (7)

For instance, as shown in FIG. 5, the outputs of the MHA 508a-g may be supplied to MLP 506a. The MLP 506a may process the outputs according to the propagation rules (e.g., shown in Equation 4 and Equation 5) to generate the encoder output hᵢ^{(L)}. The encoder output hᵢ^{(L)} may be processed using MLP 506b to determine scheduling priorities to assign to each node of the graph G. For example, the graph 512 has bars in representing scalar sequencing priorities for each node. The size of the bar may indicate the relative scheduling priority of each node. The decoder 504 processes the scalar scheduling priority for each node to determine a sequence 514.

Beneficially, these priorities may be assigned with a single NN inference. The sequence or topological order may be constructed by adding a new node at each step. Given the partial sequence σ_{1:i-1}, the next node can only be selected from a subset S(σ_{1:i-1},G) of schedulable nodes, due to both the graph topology and choices made earlier in the sequence. Then, the distribution of the next node to be added at step i is given as follows:

$$p ( {σ}_{t} \vert {σ}_{1 : t - 1} , h , G ) = \{ \begin{matrix}\frac{exp ( {{σ}_{t}}_{} )}{{\sum }_{j ∈ S ( {σ}_{1 : t - 1 ,} G )} exp ( {j}_{} )} , & if {σ}_{t} ∈ S ( {σ}_{1 : t - 1 ,} G ) \\ 0 , & Otherwise\end{matrix} \qquad ( 8 )$$

A next node 514 in the partial sequence from the distribution p(σₜ|σ_{1:t-1},h,G), may be determined, for example, using:
1. Greedy search: At each step t, select a node with the highest probability

$$( e . g . , {σ}_{t} = arg {max}_{{\tilde{σ}}_{t}} p ( {\tilde{σ}}_{t} \vert {σ}_{1 : t - 1} , h , G ) ) .$$

2. Sampling inference: At each step t, sample from the next node distribution (e.g., σₜ˜p(⋅|σ_{1:t-1}, h, G)).
3. Beam search with state-collapsing: Expand the partial sequence by using a beam search method where a score function is a total probability of the partial sequence. The beam search approach may be enhanced using the following observation: given two partial sequences in consideration, σ_{1:t} and \tilde{σ}_{1:t}, such that both have scheduled the same set of nodes so far (e.g., but different order), and C(σ_{1:t})<C(\tilde{σ}_{1:t}). Then, the partial sequence \tilde{σ}_{1:t} may be ignored and instead use only the partial sequence σ_{1:t} in the beam search. This is because both partial sequences schedule the same set of remaining nodes, and hence the set of future memory costs are identical for both σ_{1:t} and \tilde{σ}_{1:t}, but the current peak memory cost is higher for \tilde{σ}_{1:t}. Thus, σ_{1:t} dominates \tilde{σ}_{1:t} in terms of achievable minimal peak memory usage.

The architecture 500 may induce a distribution p_{θ}(σ|G) on the set of topological orders for a given DAG G. The expected cost incurred may be given by J(θ|G)= [symbol] ₚ_{_{θ(σ|G)}}_{[C(σ(θ))]}. The architecture 500 may be trained by minimizing the cost J(θ)= [symbol] _{G}[J(θ|G)] via gradient descent using the REINFORCE gradient estimator as follows:

∇J(θ)= [symbol] _{G,}_{_{pθ(σ|g)}}[(C(σ)−b(G))∇_{θ} log p_{θ}(σ|G)], (9)

where b(G) is a baseline meant to reduce the variance of the estimator. The baseline b(G) may be set equal to the cost of a greedy rollout of a baseline policy on the graph G:

$$b ( G ) = C ( \begin{matrix}arg max {p}_{θ} ( σ \vert G ) \\ σ\end{matrix} ) . \qquad ( 10 )$$

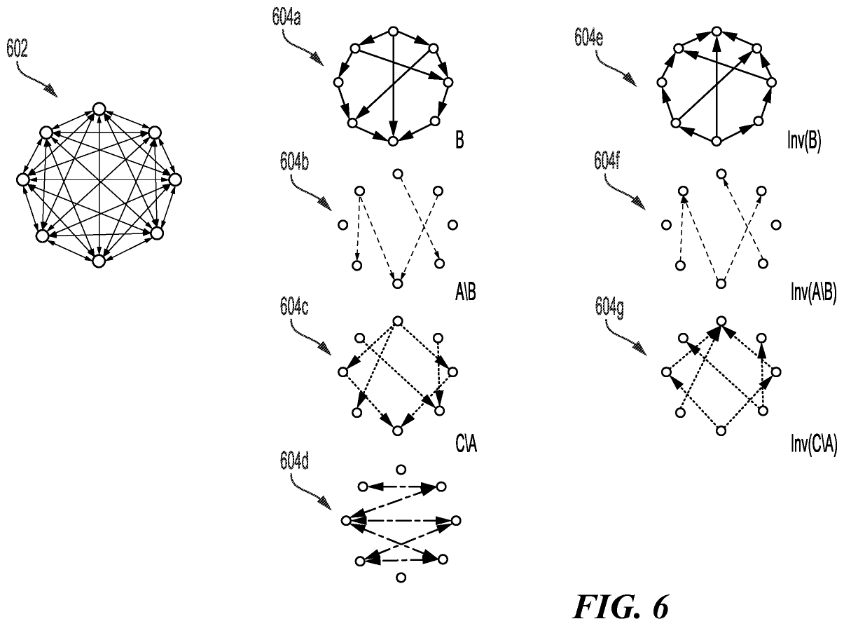

FIG. 6 is a diagram illustrating example graph topological transforms, in accordance with aspects of the present disclosure. Referring to FIG. 6, a fully connected graph 602 is shown. The fully connected graph 602 includes a set of 8 nodes which are connected in all-to all fashion. Each of the nodes may represent a task (e.g., an operation) to be performed, for example. The edges connecting the nodes of the fully connected graph 602 may indicate a relationship (e.g., an order) between the nodes. As described, information about the graph topology may be included in the node embedding generated via the encoder (e.g., 502 of FIG. 5). The fully connected graph 602 may be decomposed into subgraphs (e.g., graphs including subsets of the edges of the fully connected graph 602) via topological transforms 604a-g. Each of the subgraphs may capture different types of node-level interactions. Conversely, the subgraphs resulting from transforms 604a-g may be summed to produce the fully connected graph 602.

In some aspects, a transformer architecture may operate on each subgraph. For example, as shown in FIG. 5 an MHA (e.g., 508e-g) may be assigned to each subgraph (e.g., topologically transformed graphs 510a-d). Each transformer may be independent. In some aspects, the transformers may share parameters.

The subgraphs formed by applying the topological transforms 604a-g may be used to determine a priority for executing the nodes of the graph (e.g., see the node 512 of FIG. 5).

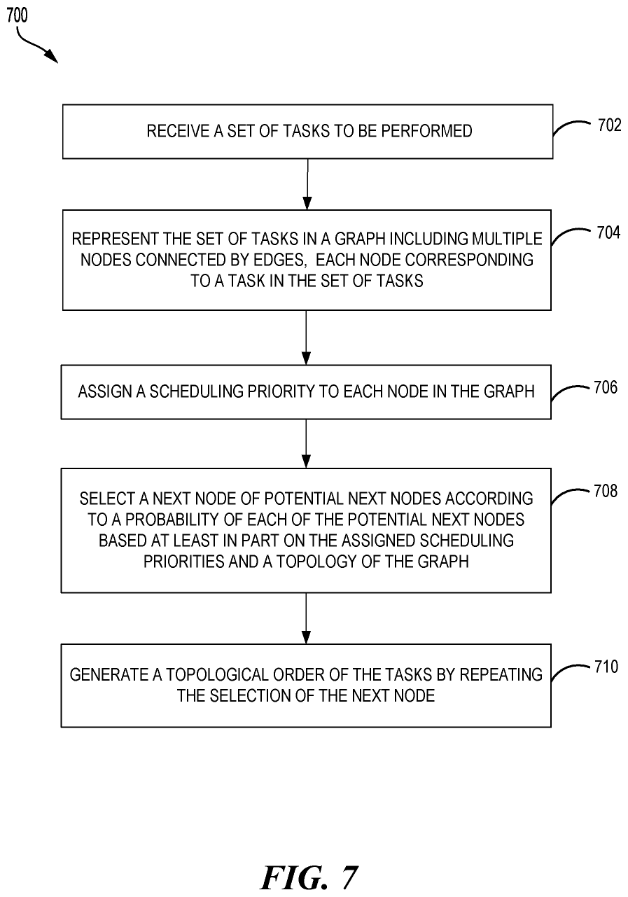

FIG. 7 is a flow diagram illustrating a processor-implemented method 700 for generating a topological order using an artificial neural network (ANN), in accordance with aspects of the present disclosure. In some aspects, the processor-implemented method 700 may be performed by a processor such as the CPU 102 or NPU 108, for example. As shown in FIG. 7, at block 702, the processor receives a set of tasks to be performed. In some aspects, the tasks may comprise operations in a computer program, for example. The tasks may, for instance, be performed by a compiler.

At block 704, the processor represents the set of tasks in a graph including multiple nodes connected by edges. Each node corresponds to task in the set of tasks. For example, as described with reference to FIG. 6, a set of tasks may be represented in a graph (e.g., the graph 602a). The graph 602 may, for example, be a DAG. The graph 602 may include multiple nodes connected by edges.

At block 706, the processor assigns a scheduling priority to each node in the graph. As described with reference to FIG. 5, scheduling priorities [symbol] ᵢ∈ [symbol] may be assigned to the nodes, rather than scheduling probabilities (e.g., 512). Furthermore, the assigned scheduling priorities may be determined based on the subgraphs formed by applying the topological transforms (e.g., see the graphs 510a-d of FIG. 5). In some aspects, the scheduling priorities for the nodes of the of graph may be assigned in a single inference.

At block 708, the processor selects a next node of potential next nodes according to a probability of each of the potential next nodes based at least in part on the assigned scheduling priorities and a topology of the graph. For example, as described with reference to FIG. 5, the next node (e.g., the node 514) may be selected based on a greedy search of a probability distribution of the potential next nodes, sampling from the probability distribution of the potential next nodes, or a beam search process.

At block 710, the processor generates a topological order of the tasks by repeating the selection of the next node. As described with reference to FIG. 5, the nodes of the graph may be ranked based on the assigned priority to generate a topological order.

### Example Aspects

Aspect 1: A processor-implemented method comprising: receiving a set of tasks to be performed; representing the set of tasks in a graph including multiple nodes connected by edges, each node corresponding to a task in the set of tasks; assigning a scheduling priority to each node in the graph; selecting a next node of potential next nodes according to a probability of each of the potential next nodes based at least in part on the assigned scheduling priorities and a topology of the graph; and generating a topological order of the tasks by repeating the selecting of the next node.

Aspect 2: The processor-implemented method of Aspect 1, in which the set of tasks comprise a set of operations to be processed by a compiler.

Aspect 3: The processor-implemented method of Aspect 1 or 2, further comprising selecting the next node based on one of a greedy search of a probability distribution of the potential next nodes, sampling from the probability distribution of the potential next nodes, or a beam search process.

Aspect 4: The processor-implemented method of any of Aspects 1-3, further comprising assigning, via an artificial neural network (ANN), the scheduling priorities to the multiple nodes with a single inference.

Aspect 5: The processor-implemented method of any of Aspects 1-4, in which the graph comprises a direct acyclic graph.

Aspect 6: The processor-implemented method of any of Aspects 1-5, in which the scheduling priority is assigned based on one or more topological transforms.

Aspect 7: The processor-implemented method of any of Aspects 1-6, further comprising performing the set of tasks according to the topological order.

Aspect 8: An apparatus, comprising: a memory; and at least one processor coupled to the memory, the at least one processor configured to: receive a set of tasks to be performed; represent the tasks in a graph including multiple nodes connected by edges, each node corresponding to a task in the set of tasks; assign a scheduling priority to each node in the graph; select a next node of potential next nodes according to a probability of each of the potential next nodes based at least in part on the assigned scheduling priorities and a topology of the graph; and generate a topological order of the tasks by repeating the selection of the next node.

Aspect 9: The apparatus of Aspect 8, in which the tasks comprise a set of operations to be processed by a compiler.

Aspect 10: The apparatus of Aspect 8 or 9, in which the at least one processor is further configured to select the next node based on one of a greedy search of a probability distribution of the potential next nodes, sampling from the probability distribution of the potential next nodes, or a beam search process.

Aspect 11: The apparatus of any of Aspects 8-10, in which the at least one processor is further configured to assign the scheduling priorities to the multiple nodes with a single inference.

Aspect 12: The apparatus of any of Aspects 8-11, in which the graph comprises a direct acyclic graph.

Aspect 13: The apparatus of any of Aspects 8-12, in which the at least one processor is further configured to assign the scheduling priorities to the multiple nodes based on one or more topological transforms.

Aspect 14: The apparatus of any of Aspects 8-13, in which the at least one processor is further configured to perform the set of tasks according to the topological order.

Aspect 15: A non-transitory computer-readable medium having program code recorded thereon, the program code executed by a processor and comprising: program code to receive a set of tasks to be performed; program code to represent the tasks in a graph including multiple nodes connected by edges, each node corresponding to a task in the set of tasks; program code to assign a scheduling priority to each node in the graph; program code to select a next node of potential next nodes according to a probability of each of the potential next nodes based at least in part on the assigned scheduling priorities and a topology of the graph; and program code to generate a topological order of the tasks by repeating the selection of the next node.

Aspect 16: The non-transitory computer-readable medium of Aspect 15, in which the tasks comprise a set of operations to be processed by a compiler.

Aspect 17: The non-transitory computer-readable medium of Aspect 15 or 16, further comprising program code to select, via an artificial neural network (ANN), the next node based on one of a greedy search of a probability distribution of the potential next nodes, sampling the probability distribution of the potential next nodes or a beam search process.

Aspect 18: The non-transitory computer-readable medium of any of Aspects 15-17, further comprising program code to assign, via an artificial neural network (ANN), the scheduling priorities to the multiple nodes with a single inference.

Aspect 19: The non-transitory computer-readable medium of any of Aspects 15-18, in which the graph comprises a direct acyclic graph.

Aspect 20: The non-transitory computer-readable medium of any of Aspects 15-19, further comprising program code to assign the scheduling priorities to the multiple nodes based on one or more topological transforms.

Aspect 21: The non-transitory computer-readable medium of any of Aspects 15-20, further comprising program code to perform the set of tasks according to the topological order.

Aspect 22: An apparatus, comprising: means for receiving a set of tasks to be performed; means for representing the tasks in a graph including multiple nodes connected by edges, each node corresponding to a task in the set of tasks; means for assigning a scheduling priority to each node in the graph; means for selecting a topological order of the tasks by repeating selection of a next node; and means for generating the topological order of the tasks by repeating the selection of the next node.

Aspect 23: The apparatus of Aspect 22, in which the tasks comprise a set of operations to be processed by a compiler.

Aspect 24: The apparatus of Aspect 22 or 23, further comprising means for selecting, via an artificial neural network (ANN), the next node based on one of a greedy search of a probability distribution of the potential next nodes, sampling from the probability distribution of the potential next nodes, or a beam search process.

Aspect 25: The apparatus of any of Aspects 22-24, further comprising means for assigning the scheduling priorities to the multiple nodes with a single inference.

Aspect 26: The apparatus of any of Aspects 22-25, in which the graph comprises a direct acyclic graph.

Aspect 27: The apparatus of any of Aspects 22-26, further comprising means for assigning the scheduling priorities to the multiple nodes based on one or more topological transforms.

Aspect 28: The apparatus of any of Aspects 22-27, further comprising means for performing the set of tasks according to the topological order.

In one aspect, the receiving means, representing means, assigning means, selecting means, generating means, performing means and/or determining means may be the GPU 104, program memory associated with the GPU 104, fully connected layers 362, NPU 428 and or the routing connection processing unit 216 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A processor-implemented method comprising:
receiving a set of tasks to be performed;
representing the set of tasks in a graph including multiple nodes connected by edges, each node corresponding to a task in the set of tasks;
assigning a scheduling priority to each node in the graph;
selecting a next node of potential next nodes according to a probability of each of the potential next nodes based at least in part on the assigned scheduling priorities and a topology of the graph; and
generating a topological order of the tasks by repeating the selecting of the next node.

2. The processor-implemented method of claim 1, in which the set of tasks comprise a set of operations to be processed by a compiler.

3. The processor-implemented method of claim 1, further comprising selecting the next node based on one of a greedy search of a probability distribution of the potential next nodes, sampling from the probability distribution of the potential next nodes, or a beam search process.

4. The processor-implemented method of claim 1, further comprising assigning, via an artificial neural network (ANN), the scheduling priorities to the multiple nodes with a single inference.

5. The processor-implemented method of claim 1, in which the graph comprises a direct acyclic graph.

6. The processor-implemented method of claim 1, in which the scheduling priority is assigned based on one or more topological transforms.

7. The processor-implemented method of claim 1, further comprising performing the set of tasks according to the topological order.

8. An apparatus, comprising:
a memory; and
at least one processor coupled to the memory, the at least one processor configured to:
receive a set of tasks to be performed;
represent the tasks in a graph including multiple nodes connected by edges, each node corresponding to a task in the set of tasks;
assign a scheduling priority to each node in the graph;
select a next node of potential next nodes according to a probability of each of the potential next nodes based at least in part on the assigned scheduling priorities and a topology of the graph; and
generate a topological order of the tasks by repeating the selection of the next node.

9. The apparatus of claim 8, in which the tasks comprise a set of operations to be processed by a compiler.

10. The apparatus of claim 8, in which the at least one processor is further configured to select the next node based on one of a greedy search of a probability distribution of the potential next nodes, sampling from the probability distribution of the potential next nodes, or a beam search process.

11. The apparatus of claim 8, in which the at least one processor is further configured to assign the scheduling priorities to the multiple nodes with a single inference.

12. The apparatus of claim 8, in which the graph comprises a direct acyclic graph.

13. The apparatus of claim 8, in which the at least one processor is further configured to assign the scheduling priorities to the multiple nodes based on one or more topological transforms.

14. The apparatus of claim 8, in which the at least one processor is further configured to perform the set of tasks according to the topological order.

15. A non-transitory computer-readable medium having program code recorded thereon, the program code executed by a processor and comprising:
program code to receive a set of tasks to be performed;
program code to represent the tasks in a graph including multiple nodes connected by edges, each node corresponding to a task in the set of tasks;
program code to assign a scheduling priority to each node in the graph;
program code to select a next node of potential next nodes according to a probability of each of the potential next nodes based at least in part on the assigned scheduling priorities and a topology of the graph; and
program code to generate a topological order of the tasks by repeating the selection of the next node.

16. The non-transitory computer-readable medium of claim 15, in which the tasks comprise a set of operations to be processed by a compiler.

17. The non-transitory computer-readable medium of claim 15, further comprising program code to select, via an artificial neural network (ANN), the next node based on one of a greedy search of a probability distribution of the potential next nodes, sampling the probability distribution of the potential next nodes or a beam search process.

18. The non-transitory computer-readable medium of claim 15, further comprising program code to assign, via an artificial neural network (ANN), the scheduling priorities to the multiple nodes with a single inference.

19. The non-transitory computer-readable medium of claim 15, in which the graph comprises a direct acyclic graph.

20. The non-transitory computer-readable medium of claim 15, further comprising program code to assign the scheduling priorities to the multiple nodes based on one or more topological transforms.

21. The non-transitory computer-readable medium of claim 15, further comprising program code to perform the set of tasks according to the topological order.

22. An apparatus, comprising:
means for receiving a set of tasks to be performed;
means for representing the tasks in a graph including multiple nodes connected by edges, each node corresponding to a task in the set of tasks;
means for assigning a scheduling priority to each node in the graph;
means for selecting a topological order of the tasks by repeating selection of a next node; and
means for generating the topological order of the tasks by repeating the selection of the next node.

23. The apparatus of claim 22, in which the tasks comprise a set of operations to be processed by a compiler.

24. The apparatus of claim 22, further comprising means for selecting, via an artificial neural network (ANN), the next node based on one of a greedy search of a probability distribution of the potential next nodes, sampling from the probability distribution of the potential next nodes, or a beam search process.

25. The apparatus of claim 22, further comprising means for assigning the scheduling priorities to the multiple nodes with a single inference.

26. The apparatus of claim 22, in which the graph comprises a direct acyclic graph.

27. The apparatus of claim 22, further comprising means for assigning the scheduling priorities to the multiple nodes based on one or more topological transforms.

28. The apparatus of claim 22, further comprising means for performing the set of tasks according to the topological order.
